(19) United States
(12) Patent Application Publication
(10) Pub. No.: US 2025/0244632 A1
(43) Pub. Date: Jul. 31, 2025

(54) CONTROL METHOD AND SYSTEM OF LITHIUM NIOBATE BASED MACH-ZEHNDER INTERFEROMETER MODULATOR

(71) Applicant: Sun Yat-sen University, Guangzhou (CN)

(72) Inventors: Xinlun CAI, Guangzhou (CN); Junlie HU, Guangzhou (CN); Zhongjin LIN, Guangzhou (CN)

(21) Appl. No.: 18/815,449

(22) Filed: Aug. 26, 2024

(30) Foreign Application Priority Data
Jan. 26, 2024 (CN) 2024101169190

(51) Int. Cl. G02F 1/21; G01B 9/02015

(52) U.S. Cl. CPC G02F 1/212; G01B 9/02027; G01B 2290/45; G02F 2202/20

(57) ABSTRACT

A control method and a control system of a lithium niobate based Mach-Zehnder interferometer modulator are disclosed. The system includes a laser, a Mach-Zehnder interferometer, a photoelectric detection module and an analog circuit bias control module. The method includes: converting, by the photoelectric detection module, two optical signals into two photocurrent signals after obtaining the two optical signals generated by the Mach-Zehnder interferometer; comparing the two photocurrent signals by a judgement unit to obtain a comparison voltage; in response to the comparison voltage being zero, keeping a bias voltage constant by a bias control unit; and in response to the comparison voltage not being zero, adjusting the bias voltage by a bias control unit according to the comparison voltage until the comparison voltage is zero.

### CROSS-REFERENCE TO RELATED APPLICATION

The present application claims priority to Chinese patent application No. 202410116919.0, entitled “Control Method and System Of Lithium Niobate Based Mach-Zehnder Interferometer Modulator”, filed on Jan. 26, 2024, the entire content of which is incorporated herein by reference.

### TECHNICAL FIELD

The disclosure relates to the technical field of optical modulation devices, in particular to a control method and a control system of a lithium niobate based Mach-Zehnder interferometer modulator.

### BACKGROUND

With a rapid development of new generation information technology, such as 5G, artificial intelligence (AI) and cloud computing, global communication traffic has experienced explosive growth, which puts forward more urgent requirements for optical communication technology. In an optical communication network, a modulator, as a core optical device, has developed from a traditional silicon-based modulator to a heterogeneous integrated modulator with better performance. In particular, a thin-film lithium niobate electro-optical modulator has gradually become one of the most popular electro-optical modulators because of its excellent linear modulation, low loss, broad bandwidth and extremely fast electro-optical response characteristics, and is widely used in optical communication networks.

When driving a Mach-Zehnder modulator, in order to effectively modulate a target signal, it is usually necessary to ensure that the Mach-Zehnder Interferometer (MZI) works at an appropriate bias point, especially in modulation modes such as On-Off Keying (OOK) and 4-level pulse amplitude modulation (PAM-4), and its working point needs to be accurately and stably biased to a quadrature point. Due to electrical characteristics of lithium niobate, under DC bias, the working point of MZI is susceptible to drift caused by environmental changes and device structure changes, which leads to modulation signal distortion and increased bit error rate, thus reducing a performance of the modulator.

At present, related MZI bias control methods include a pilot signal method and a power detection method. However, the pilot signal method requires complex detection control modules, including a pilot signal generation circuit, a photodetector, an amplifier, a filter, an analog-to-digital conversion circuit, a digital processing unit, a control unit, a digital-to-analog conversion circuit and a driving circuit, etc., which not only consumes a lot of power, but also conflicts with a goal of miniaturization and integration of the modulator. The power detection method needs to determine an output optical power at different working points in advance as a standard reference, and it is easily affected by factors such as stability of an input optical power of the laser, responsivity of the photodetector and detection efficiency, therefore stability of detection and control is poor.

### SUMMARY

A control method and a control system of a lithium niobate based Mach-Zehnder interferometer modulator is provided.

In accordance with a first aspect of the embodiments of the present disclosure, a control system of a lithium niobate based Mach-Zehnder interferometer modulator is provided, which may include a laser, a Mach-Zehnder interferometer, a photoelectric detection module and an analog circuit bias control module. The laser is configured to emit a laser light. The Mach-Zehnder interferometer is configured to receive the laser light emitted by the laser and generate two optical signals. The photoelectric detection module is configured to convert the two optical signals into two photocurrent signals after obtaining the two optical signals. The analog circuit bias control module is configured to control a bias voltage applied to the Mach-Zehnder interferometer according to the two photocurrent signals.

Optionally, the Mach-Zehnder interferometer may include a first 2×2 multimode interferometer, a second 2×2 multimode interferometer, two waveguides, three metal electrodes and two beam splitters. The three metal electrodes are arranged on two sides of the two waveguides. An output end of the first 2×2 multimode interferometer is connected with an input end of the second 2×2 multimode interferometer through the two waveguides. An output end of the second 2×2 multimode interferometer is connected with two beam splitters.

Optionally, the photoelectric detection module may include two photodetectors. The two photodetectors are independent of each other and are respectively connected with the analog circuit bias control module through wires. Alternately, an output end of one of the two photodetectors is connected with an input end of another one of the two photodetectors. A node between the two photodetectors is connected with the analog circuit bias control module through a wire.

Optionally, the analog circuit bias control module may include a judgement unit and a bias control unit. The judgement unit may be selected from a group consisting of two trans-impedance amplifiers and a subtracter in combination, a charge integrator and a comparator, and the bias control unit may be selected from a group consisting of a proportional-integral-differential controller, a voltage amplifier and a voltage scanner.

In accordance with a second aspect of the embodiments of the present disclosure, a control method of a lithium niobate based Mach-Zehnder interferometer modulator is provided, which is applied to the control system as described above and may include:
generating, by the Mach-Zehnder interferometer, two optical signals from laser light emitted by the laser,
converting, by the photoelectric detection module, the two optical signals into two photocurrent signals after obtaining the two optical signals;
comparing, by a judgement unit in the analog circuit bias control module, the two photocurrent signals to obtain a comparison voltage;
in response to the comparison voltage being zero, keeping, by a bias control unit in the analog circuit bias control module, the bias voltage constant; and
in response to the comparison voltage not being zero, adjusting, by the bias control unit, the bias voltage according to the comparison voltage until the comparison voltage is zero.

Optionally, the judgement unit may include two trans-impedance amplifiers and a subtractor, the comparing, by a judgement unit in the analog circuit bias control module, the two photocurrent signals to obtain a comparison voltage may include:
respectively converting the two photocurrent signals into a first output voltage and a second output voltage by the two trans-impedance amplifiers, and inputting the first output voltage and the second output voltage into the subtractor; and
obtaining a voltage difference between the first output voltage and the second output voltage by the subtractor, where the voltage difference is the comparison voltage.

Optionally, the judgement unit may be a charge integrator, the converting, by the photoelectric detection module, the two optical signals into two photocurrent signals after obtaining the two optical signals may include:
converting the two optical signals into two photocurrent signals, and obtaining a current difference signal between the two photocurrent signals;
where, the photoelectric detection module may include two photodetectors, an output end of one photodetector is connected with an input end of the other photodetector, and a node between the two photodetectors is connected with the analog circuit bias control module through wires.

Optionally, the comparing, by a judgement unit in the analog circuit bias control module, the two photocurrent signals to obtain a comparison voltage may further include:
obtaining, by the charge integrator, a charge integration voltage according to the current difference signal, where the charge integration voltage is the comparison voltage.

Optionally, the bias control unit may be a voltage amplifier, the method may further include:
in response to the charge integration voltage being a constant voltage, keeping, by the bias control unit, the bias voltage constant; and
in response to the charge integration voltage not being a constant voltage, adjusting, by the bias control unit, the bias voltage according to the charge integration voltage until the charge integration voltage is the constant voltage.

Optionally, the judgement unit may be a comparator and the bias control unit may be a voltage scanner, the comparison voltage may include a high level and a low level, and the method may further include:
in response to the comparison voltage being at the low level, keeping, by the voltage scanner, the bias voltage constant;
in response to the comparison voltage being at the high level, outputting, by the voltage scanner, a sawtooth wave scanning voltage to adjust the comparison voltage until the comparison voltage is at the low level.

### BRIEF DESCRIPTION OF DRAWINGS

FIG. 1 is a schematic structural diagram of a control system of a lithium niobate based Mach-Zehnder interferometer modulator provided by an embodiment of the present disclosure;

FIG. 2 is a schematic structural diagram of a Mach-Zehnder interferometer and a photoelectric detection module provided by an embodiment of the present disclosure;

FIG. 3 is a schematic structural diagram of another control system of a lithium niobate based Mach-Zehnder interferometer modulator provided by an embodiment of the present disclosure;

FIG. 4 is a schematic structural diagram of a proportional-integral-differential controller provided by an embodiment of the present disclosure;

FIG. 5 is a schematic structural diagram of another control system of a lithium niobate based Mach-Zehnder interferometer modulator provided by an embodiment of the present disclosure;

FIG. 6 is a schematic flow chart of a control method of a lithium niobate based Mach-Zehnder interferometer modulator provided by an embodiment of the present disclosure;

FIG. 7 is a schematic structural diagram of another control system of a lithium niobate based Mach-Zehnder interferometer modulator provided by an embodiment of the present disclosure.

Description of reference numerals: 1. laser; 2. Mach-Zehnder interferometer; 3. photoelectric detection module; 4. analog circuit bias control module; 201. first 2×2 multimode interferometer; 202. first waveguide; 203. second waveguide; 204. three metal electrodes; 205. second 2×2 multimode interferometer; 206. first beam splitter; 207. second beam splitter; 301. first photodetector; 302. second photodetector; 1001. first trans-impedance amplifier; 1002. second trans-impedance amplifier; 1003. subtractor; 1004. proportional-integral-differential controller; 1102. proportional amplifier; 1103. integral amplifier; 1104. differential amplifier; 1501. charge integrator; 1502. voltage amplifier; 1901. comparator; 1902. voltage scanner.

### DETAILED DESCRIPTION

The present disclosure will be further described in detail with reference to the accompany drawings and specific embodiments. For step numbers in the following embodiments, they are only set for the convenience of explanation, and an order between steps is not limited. An execution order of each step in the embodiments can be adjusted adaptively according to an understanding of a person skilled in the art.

In the following description, reference is made to “some embodiments”, which describe a subset of all possible embodiments, but it is understood that “some embodiments” may be the same subset or different subsets of all possible embodiments, and may be combined with each other without conflict.

In the following description, the term “first/second/third” is only used to distinguish similar objects, and does not represent a specific ordering of the objects. It is understood that “first/second/third” can be interchanged in a specific order or sequence if permitted, so that the embodiments of the disclosure described here can be implemented in other orders than those illustrated or described here.

Unless otherwise defined, all technical and scientific terms used in the embodiments of the present disclosure have same meanings as commonly understood by those of ordinary skills in the technical field of the present disclosure. The terms used in the embodiments of the present disclosure are only for purpose of describing the embodiments of the present disclosure, and are not intended to limit the present disclosure.

Before the embodiment of the present disclosure is further explained in detail, the nouns and terms involved in the embodiment of the present disclosure are explained, and the nouns and terms involved in the embodiment of the present disclosure are applicable to the following explanations.

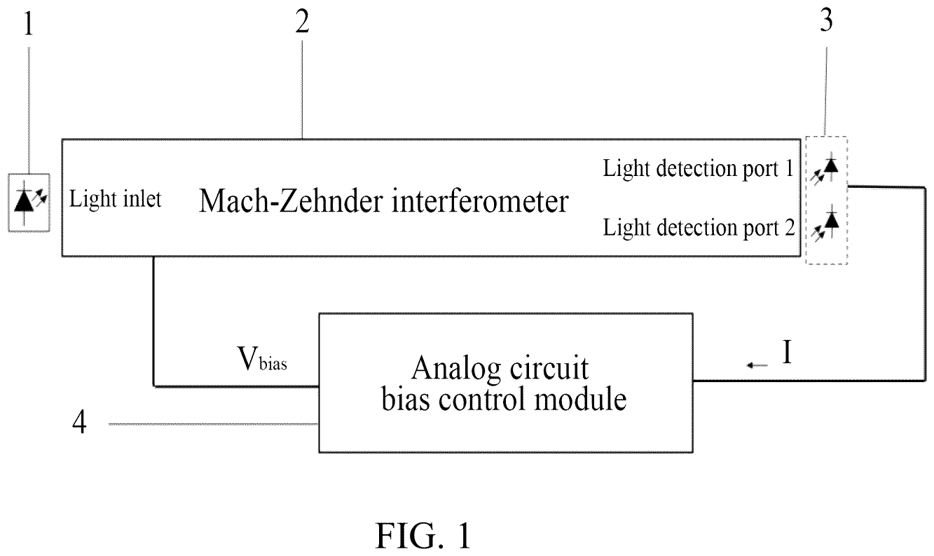

As shown in FIG. 1, an embodiment of the present disclosure provides a control system of a lithium niobate based Mach-Zehnder interferometer modulator, which includes a laser 1, a Mach-Zehnder interferometer 2, a photoelectric detection module 3 and an analog circuit bias control module 4. The laser 1 is configured to emit a laser light. The Mach-Zehnder interferometer 2 is configured to receive the laser light emitted by the laser 1 and generate two optical signals. The photoelectric detection module 3 is configured to convert the two optical signals into two photocurrent signals after obtaining the two optical signals. The analog circuit bias control module 4 is configured to control a bias voltage applied to the Mach-Zehnder interferometer 2 according to the two photocurrent signals.

Specifically, the laser light emitted by the laser 1 is input into an input end of a first 2×2 multimode interferometer 201 of the Mach-Zehnder interferometer 2, divided into two optical signals by the first 2×2 multimode interferometer 201, transmitted to a second 2×2 multimode interferometer 205 through two waveguides, and transmitted to two beam splitters through an output end of the second 2×2 multimode interferometer 205. Each of the two beam splitters has an output end for outputting an optical signal for photoelectric detection. Two optical signals for photoelectric detection are input into the photoelectric detection module 3 and converted into two photocurrent signals, and the two photocurrent signals are input into the analog circuit bias control module 4 for judgment. In response to the two photocurrent signals being equal, the analog circuit bias control module 4 keeps the bias voltage applied to the Mach-Zehnder interferometer 2, so that a working point of the Mach-Zehnder interferometer 2 is kept at an quadrature bias point. In response to the two photocurrent signals being unequal, the analog circuit bias control module 4 adjusts the bias voltage applied to the Mach-Zehnder interferometer 2, so that the working point of the Mach-Zehnder interferometer 2 moves towards the quadrature bias point until the two photocurrent signals are equal, the working point of the Mach-Zehnder interferometer 2 is at the quadrature bias point, and the analog circuit bias control module 4 maintains the bias voltage at this time.

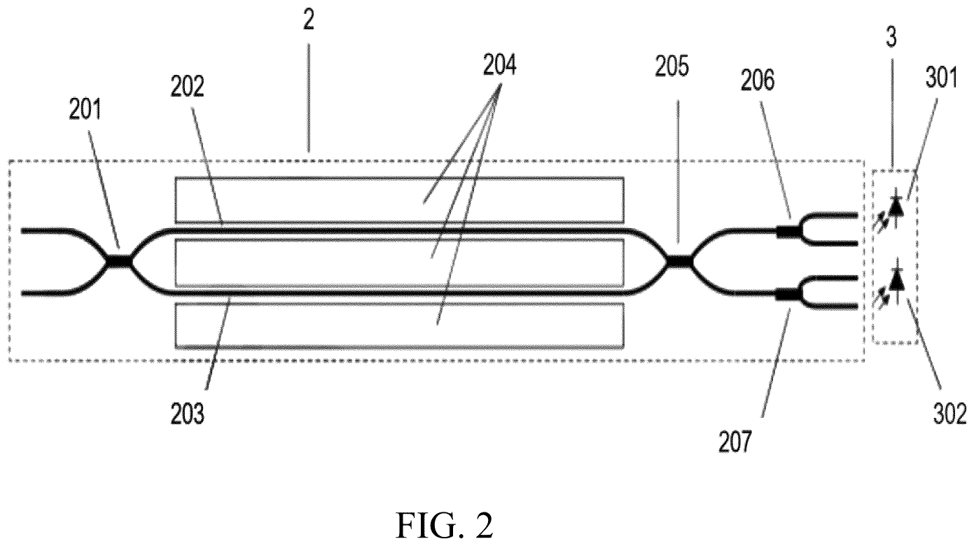

In an embodiment, as shown in FIG. 2, the Mach-Zehnder interferometer 2 adjusts phases of the two optical signals in a first waveguide 202 and a second waveguide 203 respectively by adjusting the bias voltages of three metal electrodes 204, and the two optical signals after phase adjustment interfere in the second 2×2 multimode interferometer 205 to obtain two optical signals which are respectively output to a first beam splitter 206 and a second beam splitter 207.

Specifically, by adjusting the bias voltage of the three metal electrodes 204, a phase of one of the two optical signals in the first waveguide 202 increases by q, a phase of another one of the two optical signals in the second waveguide 203 decreases by q, and the two optical signals after phase adjustment interfere in the second 2×2 multimode interferometer 205 to obtain two complementary optical signals.

In an embodiment, the laser 1 may include a tunable laser. It is understood that the laser may be determined according to actual needs, which is not limited in the embodiments of the present disclosure, and the embodiments are only provided for reference.

In an embodiment, the Mach-Zehnder interferometer 2 and/or the photoelectric detection module 3 may be arranged on a chip to form an on-chip Mach-Zehnder interferometer and/or an on-chip photoelectric detection module.

As shown in FIG. 2, the Mach-Zehnder interferometer 2 includes the first 2×2 multimode interferometer 201, the second 2×2 multimode interferometer 205, the first waveguide 202, the second waveguide 203, the three metal electrodes 204, the first beam splitter 206 and the second beam splitter 207. The three metal electrodes 204 are arranged on two sides of the two waveguides, an output end of the first 2×2 multimode interferometer 201 is connected with an input end of the second 2×2 multimode interferometer 205 through the two waveguides, and an output end of the second 2×2 multimode interferometer 205 is connected with the two beam splitters respectively.

In an embodiment, the Mach-Zehnder interferometer further includes a light inlet and two light detection ports. The light inlet is configured to enable the laser light emitted by the laser to enter the Mach-Zehnder interferometer. The two light detection ports are configured to transmit the two optical signals of Mach-Zehnder interferometer to the photoelectric detection module, respectively.

In an embodiment, materials of the first 2×2 multimode interferometer 201, the second 2×2 multimode interferometer 205, the two waveguides and the two beam splitters of the Mach-Zehnder interferometer all include lithium niobate materials. It is understood that the specific materials are determined according to actual needs, which are not limited in the embodiments of the present disclosure, and the embodiments are only provided for reference.

In an embodiment, a phase difference between the two optical signals in Mach-Zehnder interferometer is modulated by a thermo-optic effect or an electro-optic effect, thereby modulating an interference output of the two optical signals. Specifically, by applying a voltage to the metal electrodes, a refractive index difference between the two waveguides is adjusted, thereby modulating the phase difference between the two optical signals.

In an embodiment, one of the three metal electrodes located between the two waveguides in the Mach-Zehnder interferometer is connected to an output end of the analog circuit bias control module, and another two of the three metal electrodes are grounded.

In an embodiment, light splitting ratios of the first 2×2 multimode interferometer 201 and the second 2×2 multimode interferometer 205 each are 1:1, thereby ensuring that light intensities of the two optical signals passing through the 2×2 multimode interferometers are equal.

In an embodiment, only one optical signal in each of the first beam splitter 206 and the second beam splitter 207 is converted into a photocurrent signal. Light splitting ratios of the first beam splitter 206 and the second beam splitter 207 are identical. Two optical signals converted into the two photocurrent signals are output from output ends of the first beam splitter 206 and the second beam splitter 207 which have identical light splitting ratios. It is understood that the specific light splitting ratios are determined according to actual needs, which are not limited in the embodiment of the present disclosure, and the embodiments are only provided for reference. For example, the light splitting ratios of the two beam splitters are 1:99, and 1% of an optical signal is converted into a photocurrent signal in each of the two beam splitters. Alternately, the light splitting ratios of the two beam splitters are 5:95, and 5% of the optical signal is converted into the photocurrent signal in each of the two beam splitters.

Optionally, the photoelectric detection module includes two photodetectors. The two photodetectors are independent of each other and are respectively connected with the analog circuit bias control module through wires. Alternately, an output end of one of the two photodetectors is connected with an input end of another one of the two photodetectors, and a node between the two photodetectors is connected with the analog circuit bias control module through a wire.

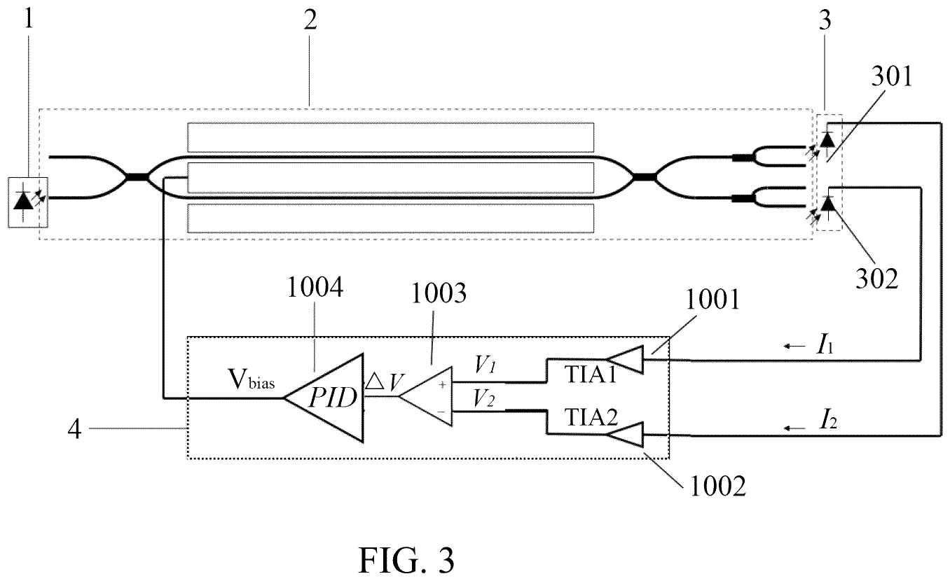

As shown in FIG. 3, a first photodetector 301 and a second photodetector 302 are independent of each other which receive two optical signals output by the two beam splitters, convert the two optical signals into two photocurrent signals, and transmit the two photocurrent signals to the analog circuit bias control module 4 through wires, respectively.

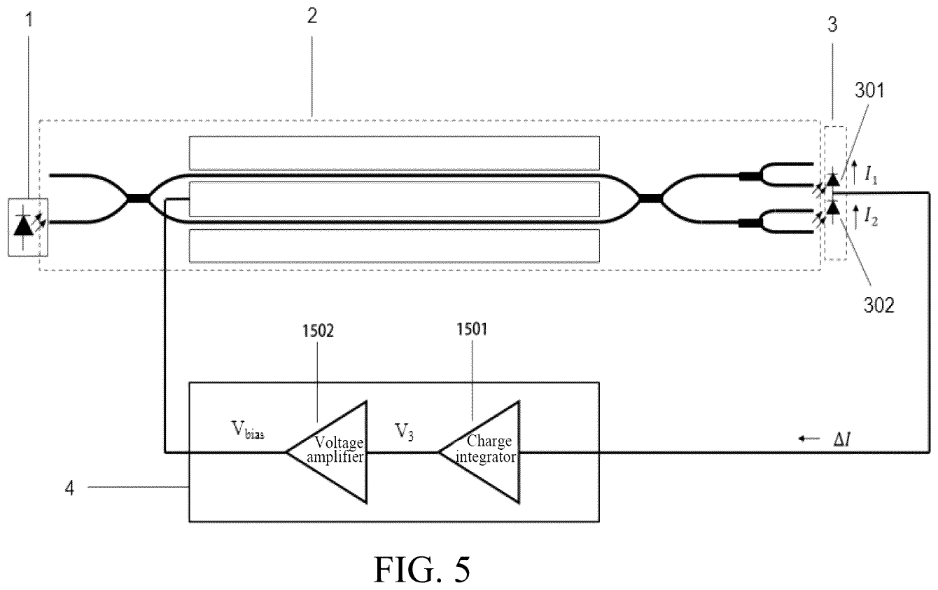

In an embodiment, as shown in FIG. 5, an input end of the first photodetector 301 is connected with an output end of the second photodetector 302. The two photodetectors respectively receive the two optical signals output by the two beam splitters, and convert the two optical signals into a photocurrent signal I₁ and a photocurrent signal I₂ with identical directions. A photocurrent output by the node between the two photodetectors is a difference ΔI between the photocurrent signal I₁ and the photocurrent signal I₂.

In an embodiment, the analog circuit bias control module includes a judgement unit and a bias control unit. The judgement unit is selected from a group consisting of two trans-impedance amplifiers and a subtracter in combination, a charge integrator and a comparator. The bias control unit is selected from a group consisting of a proportional-integral-differential controller, a voltage amplifier and a voltage scanner.

The judgement unit and the bias control unit may be combined in a manner as follow.

In an embodiment, the judgement unit is the two trans-impedance amplifiers and the subtractor, and the bias control unit is the proportional-integral-differential controller.

In an embodiment, the judgement unit is the charge integrator, and the bias control unit is the voltage amplifier.

In an embodiment, the judgement unit is the comparator, and the bias control unit is the voltage scanner.

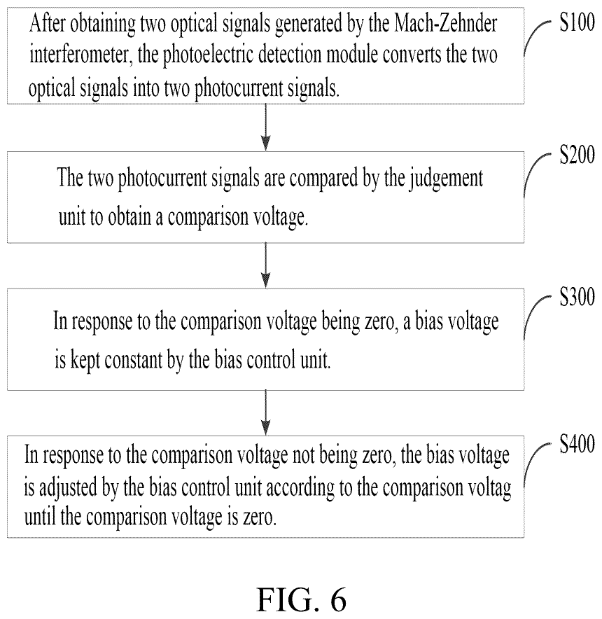

As shown in FIG. 6, a control method of a lithium niobate based Mach-Zehnder interferometer modulator is provided, which is applied to the control system as described above and may include the following steps.

S100, after obtaining two optical signals generated by the Mach-Zehnder interferometer, the photoelectric detection module converts the two optical signals into two photocurrent signals.

S200, the two photocurrent signals are compared by the judgement unit to obtain a comparison voltage.

S300, in response to the comparison voltage being zero, a bias voltage is kept constant by the bias control unit.

S400, in response to the comparison voltage not being zero, the bias voltage is adjusted by the bias control unit according to the comparison voltage until the comparison voltage is zero.

Specifically, when the phase difference between the two optical signals in the two waveguides of the Mach-Zehnder interferometer is 90°, light output by Mach Zehnder interferometer is almost unaffected by interference, and light intensities of two output light are equal, therefore the Mach-Zehnder interferometer works at the quadrature bias point.

Specifically, when a light intensity of an input light is P₀, an electric field component is Eᵢₙ=E₀e^{i(wt+φ}^{₀}⁾, in which P₀=|E₀|². Electric field components input into the two waveguides from the first 2×2 multimode interferometer are

$${E}_{in , up} = \frac{\sqrt{2}}{2} {E}_{in} {e}^{i ( - \frac{π}{2} )} , {E}_{in , down} = \frac{\sqrt{2}}{2} {E}_{in} ,$$

respectively.

After the bias voltage modulates the electric field, the electric field components in the two waveguides are

$${E}_{modulate , up} = \frac{\sqrt{2}}{2} {E}_{in} {e}^{i ( - \frac{π}{2} )} {e}^{i φ} ,$$

$${E}_{modulate , down} = \frac{\sqrt{2}}{2} {E}_{in} {e}^{i ( - φ )} ,$$

respectively.

In which Δφ=V_{bias}/V_{π}π, Δφ is a phase offset in each of the waveguides under an action of the electric field, V_{π} is a voltage required to change an optical phase by π in each of the waveguides, and V_{bias} is the bias voltage.

The electric field components of the two optical signals output from the second 2×2 multimode interferometer are

$${E}_{out , up} = \frac{\sqrt{2}}{2} {E}_{modulate , up} + \frac{\sqrt{2}}{2} {E}_{modulate , down} {e}^{i ( - \frac{π}{2} )} ,$$

$${E}_{out , down} = \frac{\sqrt{2}}{2} {E}_{modulate , up} {e}^{i ( - \frac{π}{2} )} + \frac{\sqrt{2}}{2} {E}_{modulate , down} ,$$

respectively.

Light intensities of the two optical signals output from the second 2×2 multimode interferometer are

$${P}_{out , up} = {\vert {E}_{out , up} \vert}^{2} = {\vert {E}_{0} \vert}^{2} {cos}^{2} ( \frac{{v}_{bias}}{{v}_{π}} π ) = \frac{1}{2} {\vert {E}_{0} \vert}^{2} ( 1 + cos ( 2 \frac{{v}_{bias}}{{v}_{π}} π ) ) ,$$

$${P}_{out , down} = {\vert {E}_{out , down} \vert}^{2} = {\vert {E}_{0} \vert}^{2} {sin}^{2} ( \frac{{v}_{bias}}{{v}_{π}} π ) = \frac{1}{2} {\vert {E}_{0} \vert}^{2} ( 1 - cos ( 2 \frac{{v}_{bias}}{{v}_{π}} π ) ) ,$$

respectively.

When

$$\frac{{v}_{bias}}{{v}_{π}} = \frac{π}{4} ,$$

a modulation phase difference between the two waveguides is

$$\frac{π}{4} - ( - \frac{π}{4} ) = \frac{π}{2} .$$

At this time, the Mach-Zehnder interferometer works at the quadrature bias point, and the light intensities of the two optical signals output by the second 2×2 multimode interferometer are equal, in which the light intensities are

$${P}_{out , up} = {P}_{out , down} = \frac{1}{2} {\vert {E}_{0} \vert}^{2} ,$$

respectively.

Assuming that all losses in the Mach-Zehnder interferometer are n, and a ratio of each of the optical signals output to the photoelectric detection module through the two beam splitters is k, when the Mach-Zehnder interferometer works at the quadrature bias point, the two optical signals output to the photoelectric detection module are equal, and the light intensities are

$${P}_{pd , up} = {P}_{pd , down} = \frac{1}{2} ηk {\vert {E}_{0} \vert}^{2} ,$$

Specifically, the photoelectric detection module detects the two optical signals output by the Mach-Zehnder interferometer, and judges whether the light intensities of the two optical signals are equal, thereby judging whether the Mach-Zehnder interferometer works at the quadrature offset point.

Specifically, the bias voltage output by the analog circuit bias control module is applied to one of the three metal electrodes between the two waveguides in the Mach-Zehnder interferometer, and another two of the three metal electrodes are grounded, therefore, electric fields in the two waveguides are opposite, and phase modulations of the two optical signals in the two waveguides are also opposite. As the bias voltage is changed, if the phase of one of the two optical signals increases by φ, the phase of another one of the two optical signals decreases by φ, thereby realizing light intensity modulations of the two optical signals, and the two optical signals with different light intensities becoming equal in intensity after modulation.

In an embodiment, the judgement unit is the two trans-impedance amplifiers and the subtractor, the step that the two photocurrent signals are compared by the judgement unit to obtain a comparison voltage specifically includes the following steps.

S111, the two photocurrent signals are respectively converted into a first output voltage and a second output voltage by the two trans-impedance amplifiers, and the first output voltage and the second output voltage are input into the subtractor.

S112, a voltage difference between the first output voltage and the second output voltage is obtained by the subtractor, and the voltage difference is the comparison voltage.

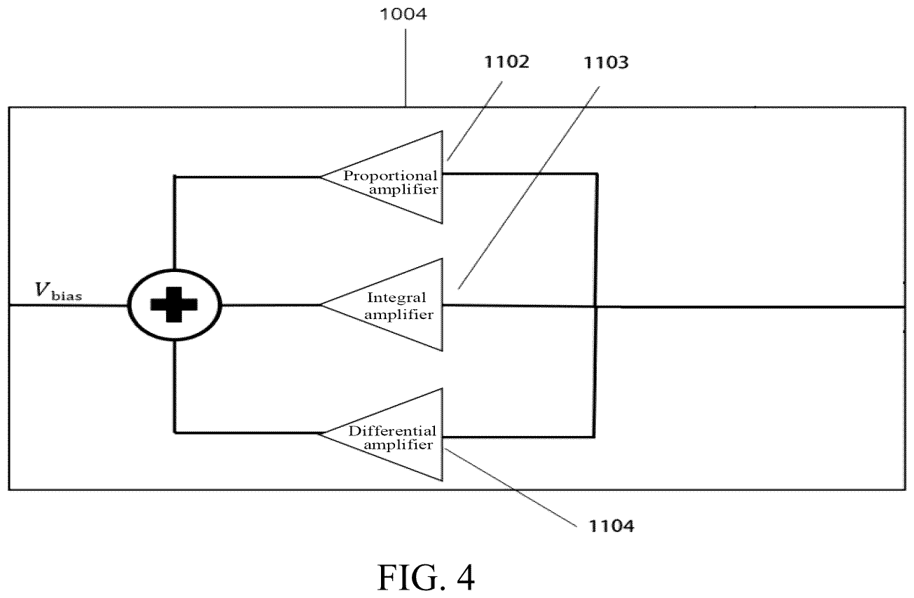

In the first embodiment, as shown in FIG. 3, the two photodetectors of the photoelectric detection module 3 are independent of each other, and are respectively connected with a first trans-impedance amplifier (TIA) 1001 and a second trans-impedance amplifier 1001 in the analog circuit bias control module through wires. As shown in FIG. 4, a proportional-integral-differential controller 1004 includes a proportional amplifier 1102, an integral amplifier 1103 and a differential amplifier 1104.

In a first embodiment, a control method of a lithium niobate based Mach-Zehnder interferometer modulator is provided, which is applied to the system shown in FIG. 3. The judgment unit is the first trans-impedance amplifier 1001, the second trans-impedance amplifier 1002 and the subtractor 1003. The bias control unit is the proportional-integral-differential controller 1004. The method specifically includes the following steps.

After obtaining two optical signals generated by the Mach-Zehnder interferometer, the photoelectric detection module 3 converts the two optical signals into the photocurrent signal I₁ and the photocurrent signal I₂.

The first trans-impedance amplifier 1001 and the second trans-impedance amplifier 1002 respectively convert the photocurrent signal I₁ and the photocurrent signal I₂ into a first voltage V₁ and a second voltage V₂, and transmit the first voltage V₁ and the second voltage V₂ to the subtractor 1003 to obtain a voltage difference ΔV between the first voltage V₁ and the second voltage V₂, in which ΔV is the comparison voltage.

In response to the voltage difference ΔV being zero, the bias voltage V_{bias} is kept constant by the proportional-integral-differential controller.

In response to the voltage difference ΔV not being zero, the proportional-integral-differential controller 1004 adjusts the bias voltage V_{bias} according to the voltage difference ΔV until the voltage difference ΔV is zero.

Specifically, a preset voltage is set in the proportional-integral-differential controller 1004 in the first embodiment. The voltage difference ΔV is compared with the preset voltage. In response to the voltage difference ΔV being unequal to the preset voltage, the proportional amplifier 1102 slightly adjusts the bias voltage according to a preset ratio, thereby tapering the voltage difference ΔV to zero. By accumulating errors, the integrating amplifier 1103 can adjust the working point of the Mach-Zehnder interferometer more quickly, which is beneficial to keep the Mach-Zehnder interferometer stable for a long time. The differential amplifier 1104 is configured to predict future changes of the voltage difference ΔV, so that the bias voltage can be stabilized at a voltage value that enables the Mach-Zehnder interferometer to work at the quadrature bias point. In an embodiment, the preset voltage is 0.

In an embodiment, the judgement unit is the charge integrator, the step that after obtaining the two optical signals generated by the Mach-Zehnder interferometer, the photoelectric detection module converts the two optical signals into two photocurrent signals further includes the following step.

S121, after converting the two optical signals into the two photocurrent signals, a current difference signal of the two photocurrent signals is obtained.

Specifically, in the photoelectric detection module, an output end of one of the two photodetectors is connected with an input end of another one of the two photodetectors, and a node between the two photodetectors is connected with the analog circuit bias control module through a wire.

In a second embodiment, as shown in FIG. 5, the input end of the first photodetector 301 in the photoelectric detection module is connected with the output end of the second photodetector 302, the first photodetector 301 and the second photodetector 302 respectively convert the two optical signals into a photocurrent signal I₁ and a photocurrent signal 12, and a photocurrent output by the node between the first photodetector 301 and the second photodetector 302 is a difference ΔI between the photocurrent signal I₁ and the photocurrent signal 12.

In the second embodiment, a control method of a lithium niobate based Mach-Zehnder interferometer modulator is provided, which is applied to the system shown in FIG. 5. The judgement unit is a charge integrator 1501, and the bias control unit is a voltage amplifier 1502. The method specifically includes the following steps.

After converting the two optical signals into two photocurrent signals, the photocurrent signal at the node between the first photodetector 301 and the second photodetector 302 is output to the analog circuit bias control module to obtain the current difference signal ΔI of the two photocurrent signals.

Optionally, the judgement unit is the charge integrator, the step that the two photocurrent signals are compared by the judgement unit to obtain a comparison voltage further includes the following step.

S221, the charge integrator obtains a charge integration voltage according to the current difference signal, and the charge integration voltage is the comparison voltage.

In the second embodiment, the method further includes the following step.

The charge integration voltage V₃ is obtained by the charge integrator 1501 according to the current difference signal ΔI, and the charge integration voltage V₃ is the comparison voltage.

Optionally, the bias control unit is the voltage amplifier, the method further includes the following steps.

S321, in response to the charge integration voltage being a constant voltage, the bias voltage is kept constant by the bias control unit.

S421, in response to the charge integration voltage not being a constant voltage, the bias voltage is adjusted by the bias control unit according to the charge integration voltage until the charge integration voltage is the constant voltage.

In the second embodiment, the method further includes the following steps.

In response to the charge integration voltage V₃ being the constant voltage, the bias voltage V_{bias} is kept constant by the voltage amplifier 1502.

In response to the charge integration voltage not being a constant voltage, the bias voltage V_{bias} is adjusted by the voltage amplifier 1502 according to the charge integration voltage V₃, so that the bias voltage V_{bias} changes towards the bias voltage at which the Mach-Zehnder interferometer works at the quadrature bias point until the current difference signal ΔI is zero, then the charge integrator 1501 stops accumulating charges, and the charge integration voltage V₃ does not change any more.

Specifically, when the current difference signal ΔI is zero, the charge integrator 1501 does not accumulate charges, the charge integration voltage V₃ remains unchanged, and the bias voltage remains unchanged. When the current difference signal ΔI is not zero, the charge integrator 1501 accumulates the current difference signal ΔI, and the charge integration voltage V₃ changes, and the bias voltage V₃ also changes with the charge integration voltage V₃.

Optionally, the judgement unit is the comparator and the bias control unit is the voltage scanner, the comparison voltage includes a high level and a low level, and the method further includes the following steps.

S331, in response to the comparison voltage being at the low level, the bias voltage is kept constant by the voltage scanner.

S431, in response to the comparison voltage being at the high level, the voltage scanner outputs a sawtooth wave scanning voltage to adjust the comparison voltage until the comparison voltage is at the low level.

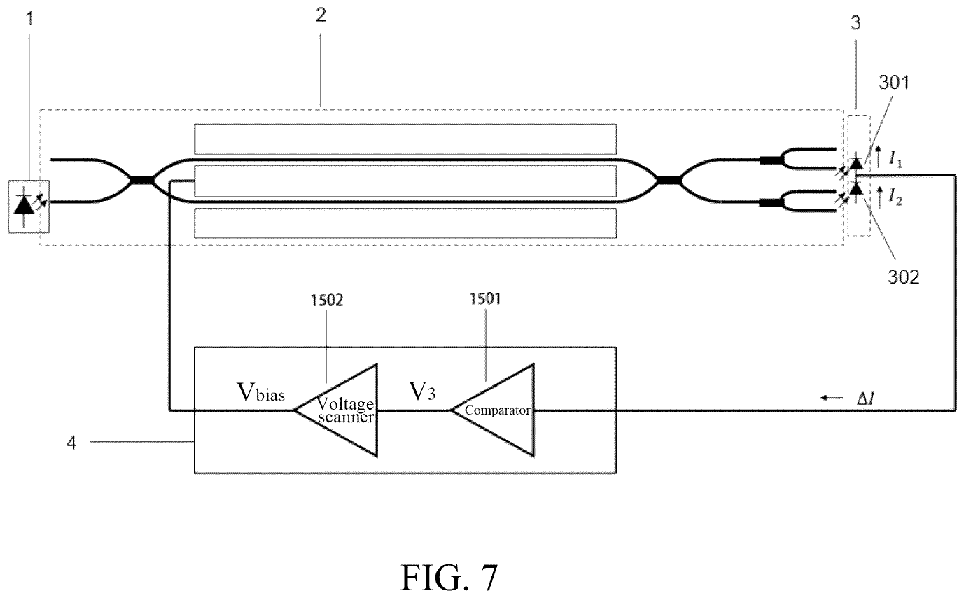

In a third embodiment, a control method of a lithium niobate based Mach-Zehnder interferometer modulator is provided, which is applied to the control system of the lithium niobate based Mach-Zehnder interferometer modulator shown in FIG. 7. The judgement unit is a comparator 1901, and the bias control unit is a voltage scanner 1902. The method includes the following steps.

After obtaining two optical signals generated by the Mach-Zehnder interferometer, the photoelectric detection module converts the two optical signals into two photocurrent signals.

The comparator 1901 compares the two photocurrent signals to obtain a comparison voltage.

In response to the comparison voltage being at the low level, the bias voltage is kept constant by the voltage scanner 1902.

In response to the comparison voltage being at the high level, the voltage scanner 1902 outputs a sawtooth wave scanning voltage to adjust the comparison voltage until the comparison voltage is at the low level.

Specifically, in response to the two photocurrent signals being equal, the comparator 1901 outputs a low level, and the voltage scanner 1902 stably outputs the scanning voltage, that is, the bias voltage is kept unchanged, so that the Mach-Zehnder interferometer is kept at the quadrature bias point.

Specifically, in response to the two photocurrent signals being unequal, the comparator 1901 outputs a high level, which triggers a scanning function of the voltage scanner 1902, so that the voltage scanner 1902 outputs a sawtooth wave scanning voltage. Due to a slow change rate of the scanning voltage, the control system provided in the embodiment has enough response time. The sawtooth wave scanning voltage gradually changes until the sawtooth wave scanning voltage is equal to the bias voltage that makes the Mach-Zehnder interferometer work at the quadrature bias point, then the two photocurrents are equal, and the comparator 1901 outputs a low level, so that the voltage scanner 1902 is triggered to output a stable scanning voltage instead of the sawtooth wave scanning voltage, and the Mach-Zehnder interferometer is kept at the quadrature bias point. A voltage range of the sawtooth wave scanning voltage includes 0 to 2 times half-wave voltage.

Further, in the above three embodiments, structures of the first embodiment and the third embodiment are relatively complex, but they are highly reliable, and can better cope with a problem of bias point drift caused by complex external interference, and have strong robustness. A circuit structure of the analog circuit bias control module of the second embodiment is simpler and easier to implement.

The embodiment of the disclosure has the following beneficial effects. The control system of the lithium niobate based Mach-Zehnder interferometer modulator is provided in the embodiments, which includes the laser configured to emit laser light; the Mach-Zehnder interferometer configured to receive the laser light emitted by the laser and generate two optical signals; the photoelectric detection module configured to convert the two optical signals into two photocurrent signals after obtaining the two optical signals; the analog circuit bias control module configured to control the bias voltage applied to the Mach-Zehnder interferometer according to the two photocurrent signals. The analog circuit bias control module includes the judgement unit configured to judge whether the two photocurrent signals are equal or not, and the bias control unit configured to control the bias voltage according to the two photocurrent signals. The control system provided by the embodiments forms a negative feedback closed-loop control system. When the working point of the Mach-Zehnder interferometer is disturbed and drifts, the control system can dynamically adjust the bias voltage applied to the Mach-Zehnder interferometer, thereby realizing an adjustment of the working point of the Mach-Zehnder interferometer, and making the working point return to an appropriate bias point. This improves stability of the control system. The analog circuit bias control module is completely based on the analog circuit, and devices used in the judgement unit and the bias control unit are relatively simple, without complex digital control circuits, thus reducing a volume of the control system, reducing a cost of preparing the control system and reducing a power consumption of the control system. Moreover, the analog circuit bias control module can be realized on a printed circuit board (PCB) level circuit or integrated on an analog complementary metal oxide semiconductor (CMOS) circuit, which is convenient for mass production and wide application. The control method of the lithium niobate based Mach-Zehnder interferometer modulator is also provided in the embodiments, which includes the following steps. The laser light emitted by the laser passes through the Mach-Zehnder interferometer to generate two optical signals, and the photoelectric detection module converts the two optical signals into two photocurrent signals after obtaining the two optical signals. The two photocurrent signals are compared by the judgement unit in the analog circuit bias control module to obtain the comparison voltage. In response to the comparison voltage being zero, the bias voltage is kept constant by the bias control unit in the analog circuit bias control module. In response to the comparison voltage not being zero, the bias voltage is adjusted by the bias control unit according to the comparison voltage until the comparison voltage is zero. Each of the two optical signals used for photoelectric detection is a small part of light separated from the light output from the Mach-Zehnder interferometer, and the output end of the analog circuit bias control module is connected with the metal electrodes in the Mach-Zehnder interferometer, so that photoelectric detection can be performed while the Mach-Zehnder interferometer is working, and a working state of the Mach-Zehnder interferometer can be fed back in real time. In response to the two photocurrents being unequal, the analog circuit bias control module can immediately detect and timely adjust the bias voltage applied to the Mach-Zehnder interferometer, thereby timely adjusting the phase difference of the two optical signals in the Mach-Zehnder interferometer, and making the working point of the Mach-Zehnder interferometer return to the quadrature bias point to realize an accurate and efficient Mach-Zehnder interferometer modulation. This system is less susceptible to external interferences, and has strong robustness. There is no need to determine an output optical power at different working points in advance, thus improving the stability. The proportional-integral-differential controller is also used to eliminate static errors and reduce overshoot and oscillation in the control system, which is beneficial to maintain long-term stability of the control system.

The above is a detailed description of the embodiments of the present disclosure, but the disclosure is not limited to the above embodiments, and those of ordinary skills in the art can make various equivalent deformations or substitutions without violating a gist of the present disclosure, which are included in a scope defined by the claims of this application.

What is claimed is:

1. A control system of a lithium niobate based Mach-Zehnder interferometer modulator, comprising a laser, a Mach-Zehnder interferometer, a photoelectric detection module and an analog circuit bias control module; wherein
the laser is configured to emit laser light;
the Mach-Zehnder interferometer is configured to receive the laser light emitted by the laser and generate two optical signals;
the photoelectric detection module is configured to convert the two optical signals into two photocurrent signals after obtaining the two optical signals; and
the analog circuit bias control module is configured to control a bias voltage applied to the Mach-Zehnder interferometer according to the two photocurrent signals.

2. The control system of a lithium niobate based Mach-Zehnder interferometer modulator of claim 1, wherein the Mach-Zehnder interferometer comprises a first 2×2 multimode interferometer, a second 2×2 multimode interferometer, two waveguides, three metal electrodes and two beam splitters; and
wherein the three metal electrodes are arranged on two sides of the two waveguides, an output end of the first 2×2 multimode interferometer is connected with an input end of the second 2×2 multimode interferometer through the two waveguides, and an output end of the second 2×2 multimode interferometer is connected with the two beam splitters respectively.

3. The control system of a lithium niobate based Mach-Zehnder interferometer modulator of claim 1, wherein the photoelectric detection module comprises two photodetectors; and the two photodetectors are independent of each other and are respectively connected with the analog circuit bias control module through wires; or, an output end of one of the two photodetectors is connected with an input end of another one of the two photodetectors, and a node between the two photodetectors is connected with the analog circuit bias control module through a wire.

4. The control system of a lithium niobate based Mach-Zehnder interferometer modulator of claim 1, wherein the analog circuit bias control module comprises a judgement unit and a bias control unit, the judgement unit is selected from a group consisting of two trans-impedance amplifiers and a subtractor in combination, a charge integrator and a comparator, and the bias control unit is selected from a group consisting of a proportional-integral-differential controller, a voltage amplifier and a voltage scanner.

5. A control method of a lithium niobate based Mach-Zehnder interferometer modulator, which is applied to a control system of a lithium niobate based Mach-Zehnder interferometer modulator;
the system comprising a laser, a Mach-Zehnder interferometer, a photoelectric detection module and an analog circuit bias control module; wherein the laser is configured to emit laser light; the Mach-Zehnder interferometer is configured to receive the laser light emitted by the laser and generate two optical signals; the photoelectric detection module is configured to convert the two optical signals into two photocurrent signals after obtaining the two optical signals; and the analog circuit bias control module is configured to control a bias voltage applied to the Mach-Zehnder interferometer according to the two photocurrent signals,
the method comprising:
generating, by the Mach-Zehnder interferometer, two optical signals from laser light emitted by the laser,
converting, by the photoelectric detection module, the two optical signals into two photocurrent signals after obtaining the two optical signals;
comparing, by a judgement unit in the analog circuit bias control module, the two photocurrent signals to obtain a comparison voltage;
in response to the comparison voltage being zero, keeping, by a bias control unit in the analog circuit bias control module, the bias voltage constant; and
in response to the comparison voltage not being zero, adjusting, by the bias control unit, the bias voltage according to the comparison voltage until the comparison voltage is zero.

6. The control method of a lithium niobate based Mach-Zehnder interferometer modulator of claim 5, wherein the judgement unit comprises two trans-impedance amplifiers and a subtractor, the comparing, by a judgement unit in the analog circuit bias control module, the two photocurrent signals to obtain a comparison voltage comprises:
respectively converting the two photocurrent signals into a first output voltage and a second output voltage by the two trans-impedance amplifiers, and inputting the first output voltage and the second output voltage into the subtractor; and
obtaining a voltage difference between the first output voltage and the second output voltage by the subtractor, wherein the voltage difference is the comparison voltage.

7. The control method of a lithium niobate based Mach-Zehnder interferometer modulator of claim 5, wherein the judgement unit is a charge integrator, the converting, by the photoelectric detection module, the two optical signals into two photocurrent signals after obtaining the two optical signals comprises:
converting the two optical signals into two photocurrent signals, and obtaining a current difference signal between the two photocurrent signals;
wherein, the photoelectric detection module comprises two photodetectors, an output end of one photodetector is connected with an input end of the other photodetector, and a node between the two photodetectors is connected with the analog circuit bias control module through wires.

8. The control method of a lithium niobate based Mach-Zehnder interferometer modulator of claim 7, wherein the comparing, by a judgement unit in the analog circuit bias control module, the two photocurrent signals to obtain a comparison voltage further comprises:
obtaining, by the charge integrator, a charge integration voltage according to the current difference signal, wherein the charge integration voltage is the comparison voltage.

9. The control method of a lithium niobate based Mach-Zehnder interferometer modulator of claim 8, wherein the bias control unit is a voltage amplifier, the method further comprises:
in response to the charge integration voltage being a constant voltage, keeping, by the bias control unit, the bias voltage constant; and
in response to the charge integration voltage not being a constant voltage, adjusting, by the bias control unit, the bias voltage according to the charge integration voltage until the charge integration voltage is the constant voltage.

10. The control method of a lithium niobate based Mach-Zehnder interferometer modulator of claim 5, wherein the judgement unit is a comparator and the bias control unit is a voltage scanner, the comparison voltage comprises a high level and a low level, and the method further comprises:
in response to the comparison voltage being at the low level, keeping, by the voltage scanner, the bias voltage constant;
in response to the comparison voltage being at the high level, outputting, by the voltage scanner, a sawtooth wave scanning voltage to adjust the comparison voltage until the comparison voltage is at the low level.
